(19) United States
(12) Patent Application Publication
(10) Pub. No.: US 2012/0284308 A1
(43) Pub. Date: Nov. 8, 2012

(54) STATISTICAL SPELL CHECKER

(75) Inventor: Andrei Paduroiu, Waltham, MA (US)

(73) Assignee: Vistaprint Technologies Limited

(21) Appl. No.: 13/098,961

(22) Filed: May 2, 2011

(51) Int. Cl. G06F 17/30

(52) U.S. Cl. 707/780; 707/E17.014

(57) ABSTRACT

Methods, systems, and computer media implement a statistical spell checker for extracting suggested spell-check candidates for a query containing an unrecognized word. Vocabulary statistics are maintained, including recording a plurality of adjacent word sequences found in a document corpus. When a user query is received that contains a word not in the vocabulary database, i.e., an unrecognized word, the vocabulary statistics are consulted to find word sequences containing the same preceding word and/or succeeding word. The found word sequences may be returned in order based upon the conditional probability that given the recognized preceding and/or succeeding word(s), the unrecognized word is meant to be the suggested spell-checked word.

### BACKGROUND OF THE INVENTION

The present invention relates generally to search engines, and more particularly to a statistical spell checker for automatically adjusting a user query when words in the query do not exist in the index database.

Spell checking is one of the most widely known features for all office productivity software. It allows users to identify badly written words and correct them to other versions that are close to them, either by typographic distance or that “sound alike”. In a search engine, spell correction is used to automatically adjust the user query in case one or more words in that query do not exist in the known vocabulary. The known vocabulary is typically stored in a vocabulary database and built on the words that exist in all the documents processed by the search engine.

There are various types of spell correction currently used in office tools and search engines. One type of spell correction is known as “typographic” or “Edit-Distance” spell checking. An Edit Distance (ED) spell checker attempts to correct mistakes that usually result as part of mis-typing words. That is, the ED spell checker finds one or more words that are within a specific edit distance (additions, deletions, replacements) of the original word. Various algorithms exist to calculate the edit distance. For example, one algorithm, known as the Levenshtein Distance algorithm, compares the word to all expressions in the vocabulary. The edit distance is then calculated for each such comparison. All the words that have an edit-distance of below a certain threshold are returned as possible candidates.

Another type of spell correction used by search engines is known as “phonetic” spell checking. A phonetic spell checker is used to correct words that a user may not know how to spell but may know how to pronunciate. One example of a phonetic spell checker utilizes a “Double Metaphone” algorithm to find substitute query word candidates. In the Double Metaphone algorithm, each word in the vocabulary is run through a phonetic encoder whenever the search engine index is indexed to create a phonetic index which keys words by their phonetic keys. Then, during a query, when a word needs to be spell corrected, that word is run through the phonetic encoder, and its phonetic key is obtained. If the phonetic key exists in the phonetic index, all words associated with the key are returned.

While Edit Distance spell checking can yield highly relevant results, its reliance on word comparisons (sometimes tens of thousands of distinct word comparisons) and edit-distance calculations may tax the processor(s) running the spell checker. The user may experience a noticeable delay between typing the query and being presented with suggested spell-check candidates. Phonetic spell-checking can also yield good results, but requires the user to know how to pronounce the word(s) in the query. There are certain optimizations that can be made to the Edit Distance spell checking algorithm, such as narrowing down the search space to only vocabulary expressions starting or ending in the same letters and the word to be corrected, but it still does not completely solve the problem of taking too long to find a good spell correction.

Alternative solutions are sought.

### SUMMARY OF THE INVENTION

Embodiments of the invention include a method for extracting suggested spell-check candidates for a query containing an unrecognized word. The method includes determining a plurality of adjacent word sequences found in a document corpus, the adjacent word sequences comprising a plurality of adjacent recognized words. The method includes determining whether the unrecognized word is preceded by a preceding recognized word in the query and determining whether the unrecognized word is succeeded by a succeeding recognized word in the query. The method includes returning one or more of the adjacent word sequences that comprises at least the preceding recognized word in the query followed by a suggested known vocabulary word or a suggested known vocabulary word succeeded by the succeeding recognized word in the query. The method calculates the conditional probability of suggested words given the recognized preceding word and/or recognized succeeding word.

In an embodiment, a non-transitory computer readable storage includes program instructions which, when executed by a computer, implement the methods described herein.

In an embodiment, a computerized apparatus or system implements a statistical spell checker which performs the methods described herein.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an exemplary system implementing an embodiment of the invention;

FIG. 2 is a flowchart illustrating an exemplary method for generating vocabulary statistics;

FIG. 3 diagrammatically illustrates a set of two-word sequences;

FIG. 4 depicts an exemplary set of web pages that may be part of a larger web site that implements a search engine that utilizes statistical spell-checking in processing user queries;

FIG. 5 is a flowchart illustrating an exemplary method for generating suggested spell-check candidates for unrecognized words in a user query; and

FIG. 6 is a block diagram of an exemplary computing environment in which a statistical spell checker may operate.

### DETAILED DESCRIPTION

In embodiments of the invention, a spell checker utilizes statistics to reduce the number of comparisons of an unrecognized word or phrase to known vocabulary in a vocabulary database. The reduction in word comparisons reduces the time it takes to produce relevant spell-check candidates for any unrecognized words or phrases.

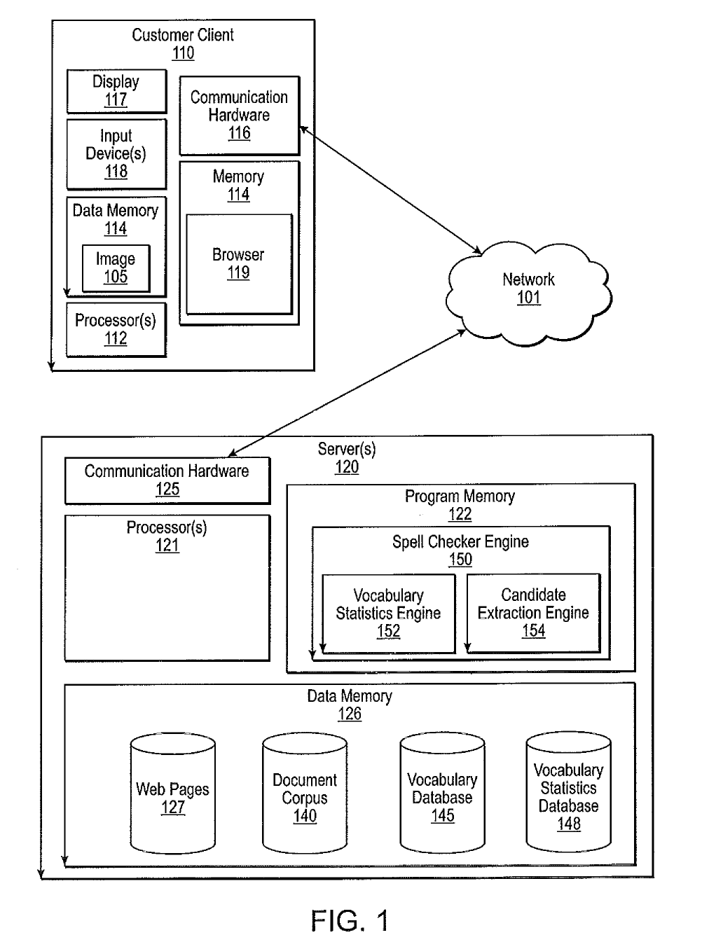

Turning now to the drawings, FIG. 1 shows an exemplary computer environment in which embodiments of the invention may operate. As illustrated in FIG. 1, a server 120 includes one or more processors 121, program memory 122 which stores computer-readable instructions for processing by the processor(s) 121, and communication hardware 125 for communicating with remote devices such as client computer(s) 110 over a network 101 such as the Internet. The program memory 122 includes program instructions implementing a spell-checking engine 150 which may be used in a search engine for one or more of the web sites hosted by the server. The server includes, or is configured to access, data memory 126. Data memory 126 stores data such as web pages 127 for one or more web sites, one or more documents (known as the document corpus 140), a vocabulary database 145, and vocabulary statistics 148.

Memory 122, 126, and 114 may be embodied in any one or more computer-readable storage media of one or more types, such as but not limited to RAM, ROM, hard disk drives, optical drives, disk arrays, CD-ROMs, floppy disks, memory sticks, etc. Memory 122, 126, and 114 may include permanent storage, removable storage, and cache storage, and further may comprise one contiguous physical computer readable storage medium, or may be distributed across multiple physical computer readable storage media, which may include one or more different types of media.

One or more client computer(s) 110 (only one shown in FIG. 1) is conventionally equipped with one or more processors 112, computer storage memory 114 for storing program instructions and data, and communication hardware 116 configured to connect the client computer 110 to the server 120 via the network 101. The client 110 includes a display 117 and input hardware 118 such as a keyboard, mouse, etc., and may configured to execute a browser 119 which allows the customer to navigate to a web site served by the server 120 and display web pages 127 served from the server on the display 117.

In the embodiment shown, the statistical spell-checking engine 150 is hosted by a server of a particular web site to allow searching of the web site. In alternative embodiments, the spell-checking engine 150 may be implemented as part of an Internet search engine for querying large portions of the Internet, and/or may be implemented as part of a user application program (such as a word processor (not shown) operating on a server such as 120 or on a client such as 110).

The statistical spell checker engine 150 includes a vocabulary builder engine 156, a vocabulary statistics engine 152, and a candidate extraction engine 154. The vocabulary builder engine 156 generally processes a set of documents, referred to as the document corpus 140, to extract words from the documents to store and maintain in a database of known vocabulary (i.e., the Vocabulary Database 145). The vocabulary statistics engine 152 generally processes the document corpus 140 to extract sequences of adjacent words and to generate statistics pertaining to how often various sequences of words appear together and the conditional probability that given one word, various other words will appear after or before it. Extracted sequences of words and their associated statistics are stored in a vocabulary statistics database 148. The candidate extraction engine 154 receives queries or sequences of typed-in words, checks the received query for any unrecognized words, and returns candidate corrections for unrecognized words for presentation to the user. In an embodiment, queries/input word sequences are received via a user's browser when a user is querying a web site's site-specific search engine. Alternatively, if the spell-checker 150 is implemented as part of an Internet search engine, the query is received via a user's browser when the user is using the search engine. Alternatively, if the spell-checker 150 is implemented as part of an office application (such as a word processor), the spell-checker retrieves user-entered text from the user's open document.

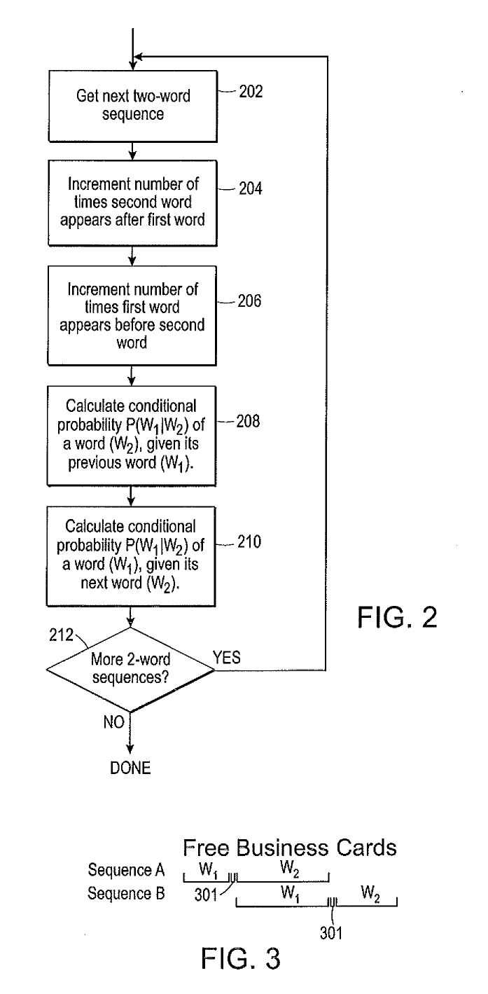

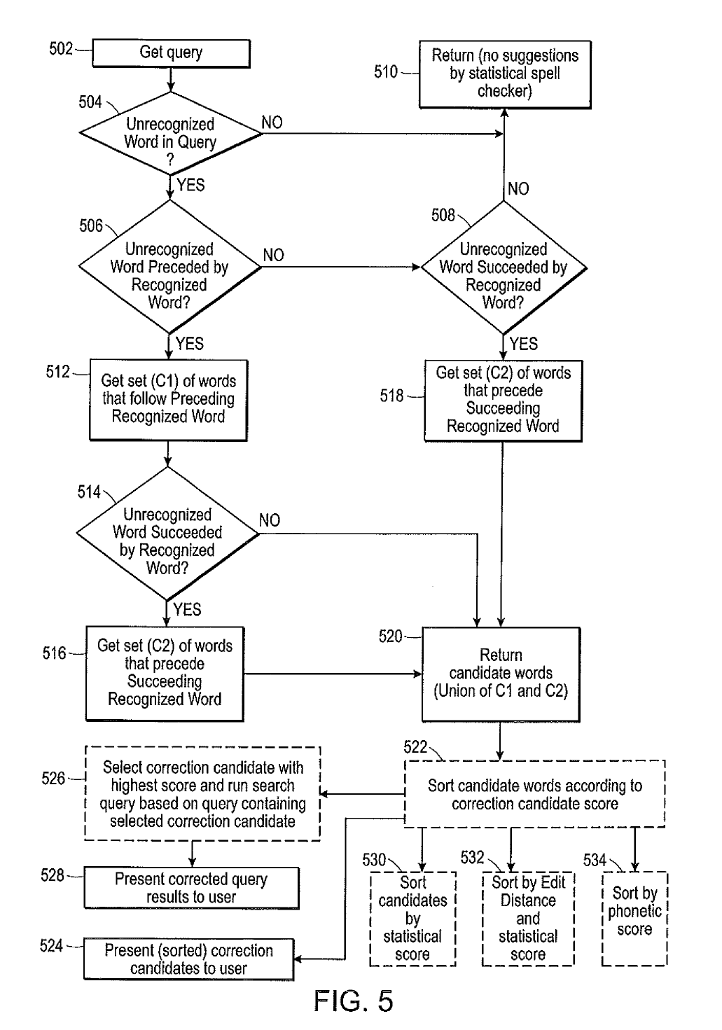

FIGS. 2 and 5 together illustrate an exemplary method for generating vocabulary candidates for an unrecognized word or phrase using statistical spell checking. FIG. 2 illustrates a method performed by the vocabulary statistics engine 152 for generating vocabulary statistics, which are used by the candidate extraction engine 154 in finding suggested spell-check candidates for unrecognized words in user queries.

As illustrated in FIG. 2, the vocabulary statistics engine 152 extracts adjacent two-word sequences from the document corpus 140 (step 202). Preferably, each document present in the document corpus 140 is processed to extract every possible two-word sequence. As illustrated in FIG. 3, a two-word sequence is a set of two adjacent words, W₁ immediately followed by W₂. (For word parsing purposes, one or more space or character delimiters 301 separate the words W₁ and W₂ but no other words appear between W₁ and W₂). For example, in FIG. 3, there are two two-word sequences: Sequence A consisting of “Free Business” and Sequence B consisting of “Business Cards”.

Once an adjacent two-word sequence is extracted from the corpus 140, a forward sequence counter representing the number of times the second word W₂ in the sequence appears immediately after the first word W₁ in the document corpus 140 is incremented (step 204). Similarly, a reverse sequence counter representing the number of times the first word W₁ in the sequence appears before the second word W₂ in the document corpus 140 is incremented (step 206). If the sequence has not yet appeared during the processing of the corpus 140, each of a new forward sequence counter and a reverse sequence counter is created and associated with the extracted sequence, initialized (to zero), and incremented.

In an embodiment, the conditional probabilities P(W₂|W₁) and P(W₁|W₂) are calculated (steps 208 and 210). That is, the probability that that the second word W₂ appears after the first word W₁ given the first word W₁ is calculated (step 208), and the probability that the first word W₁ appears before the second word W₂ given the second word W₂ is calculated (step 210).

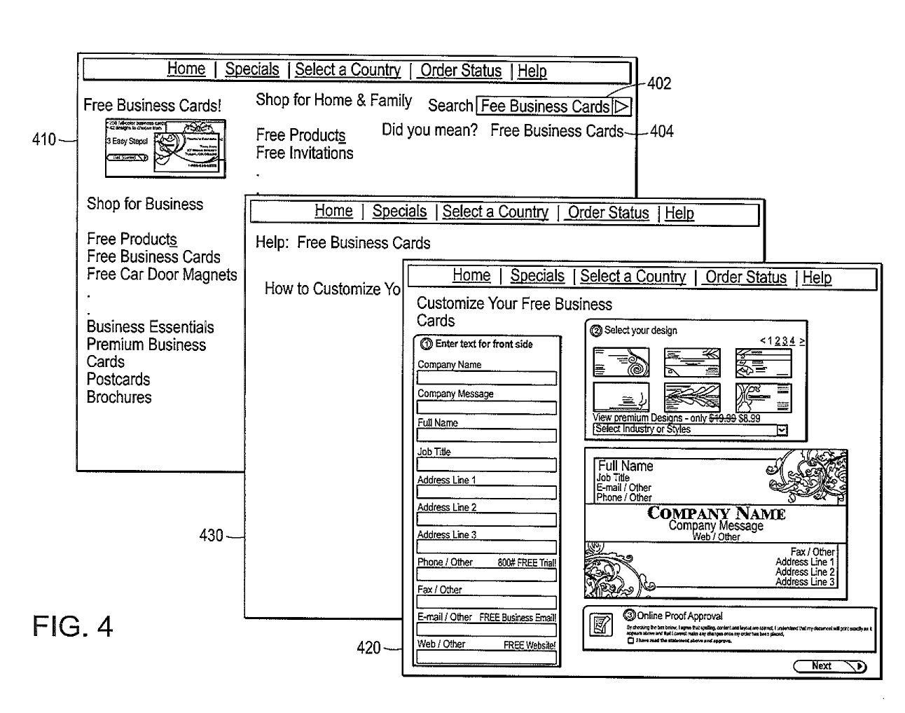

To illustrate, FIG. 4 shows an exemplary set of web pages that may be part of a larger web site. As illustrated, the set of web pages includes a Home Page 410, a Free Business Cards page 420, and a Help page 430. Each of these pages 410, 420, 430 (and additional web pages not shown) includes text content. For example, Home Page 410 includes navigation menus advertising “Free Products”, which include text “Free Business Cards”, “Free Car Door Magnets”, etc. The vocabulary statistics engine 152 processes each page 410, 420, 430 to extract each two-word sequence according to the method described in FIG. 2. It will be understood that there may be many more additional web pages, each having additional text that is processed by the vocabulary statistics engine 152 in a similar manner.

The following table (TABLE 1) (illustrative but not complete) may be generated by the vocabulary statistics engine 152 based on the web pages shown in FIG. 4:

TABLE 1

| 2-word | Forward | Reverse | | |
|---|---|---|---|---|
| Sequence | Sequence | Sequence | | |
| W₁:W₂ | Counter | Counter | P(W₂\|W₁) | P(W₁\|W₂) |
| Shop for | 2 | 2 | .5 | .2 |
| for Business | 1 | 1 | .3 | .4 |
| for Home | 1 | 1 | .2 | .3 |
| Home Family | 1 | 1 | .4 | .6 |
| Free Products | 2 | 2 | .1 | .2 |
| Free Business | 5 | 5 | .2 | .2 |
| Business Cards | 6 | 6 | .4 | .3 |
| Free Car | 1 | 1 | .1 | .2 |
| Car Door | 1 | 1 | .5 | .6 |
| Door Magnets | 1 | 1 | .5 | .3 |
| . | | | | |
| . | | | | |
| . | | | | |
| How to | 1 | 1 | .8 | .1 |
| To Customize | 1 | 1 | .1 | .3 |
| Customize Your | 2 | 2 | .4 | .3 |
| Your Free | 2 | 2 | .2 | .5 |
| . | | | | |
| . | | | | |
| . | | | | |

Given an extracted two-word sequence “W₁ W₂”, the conditional probabilities P(W₂|W₁) and P(W₁|W₂) are calculated (steps 208 and 210). That is, the conditional probability P(W₂|W₁) that the second word W₂ appears after the first word W₁ given the first word W₁ is calculated (step 208). The Conditional Probability P(W₂|W₁) is defined as the joint probability of W₁ and W₂ over the unconditional probability of W₁, or:

$$P ( {W}_{2} \vert {W}_{1} ) = \frac{P ( {W}_{1} ⋂ {W}_{2} )}{P ( {W}_{1} )} .$$

Furthermore, the conditional probability P(W₁|W₂) that the first word W₁ appears before the second word W₂ given the second word W₂ in the sequence is also calculated (step 210). The Conditional Probability P(W₁|W₂) is defined as the Joint Probability of W₁ and W₂ over the unconditional probability of W₂, or:

$$P ( {W}_{1} \vert {W}_{2} ) = \frac{P ( {W}_{1} ⋂ {W}_{2} )}{P ( {W}_{2} )} .$$

TABLE 1 also lists some example conditional probability calculations for each of the illustrated 2-word sequences.

FIG. 5 is a flowchart illustrating an exemplary method for generating suggested spell-check candidates by the candidate extraction engine 154 upon receipt of a query. As used herein, a query may be a set of words input by a user to a search engine, or alternatively may be a set of adjacent words extracted from an open electronic document by the spell-checking engine of an office application such as a word processor. A query is obtained (step 502) and parsed to determine whether there is a word in the query that is not present in the vocabulary database (referred to as an “Unrecognized Word”) (step 504). If not, in one embodiment, the candidate extraction engine 154 returns with no candidate spell-check suggestions (step 510). (In an alternative embodiment, the candidate extraction engine 154 may continue to step 506, selecting one of the words in the phrase as an Unrecognized Word in order to find alternative candidate spell-check suggestions in case the user mis-typed one of the words and the mis-typed word happened to be a word in the vocabulary database.)

If an Unrecognized Word is detected or selected (step 504), the candidate extraction engine 154 determines whether the Unrecognized Word is preceded by any recognized word (hereinafter, “Preceding Recognized Word”) (step 506). If so, the candidate extraction engine 154 retrieves a set (C1) of words that are recognized in the vocabulary statistics database 148 as being known to follow the Preceding Recognized Word (step 512). In an embodiment, the candidate extraction engine 154 accesses the vocabulary statistics database 148, searches for the Preceding Recognized Word, and retrieves all words that appear as succeeding the Preceding Recognized Word. This set makes up the set C1. In one embodiment, all words that appear in the statistics database 148 as succeeding the Preceding Recognized Word are included in the set C1. In an alternative embodiment, only words whose Forward Sequence Count meets or exceeds a predetermined threshold are included in the set C1.

The candidate extraction engine 154 then determines whether the Unrecognized Word is succeeded by any recognized word (hereinafter “Succeeding Recognized Word”) (step 314). If so, the candidate extraction engine 154 retrieves a set (C2) of words that are recognized in the vocabulary statistics database 148 as being known to precede the Succeeding Recognized Word (step 516). In an embodiment, the candidate extraction engine 154 accesses the vocabulary statistics database 148, searches for the Succeeding Recognized Word, and retrieves all words that appear as preceding the Succeeding Recognized Word. This set makes up the set C2. In one embodiment, all words that appear in the statistics database 148 as preceding the Succeeding Recognized Word are included in the set C2. In an alternative embodiment, only words whose Reverse Sequence Count meets or exceeds a predetermined threshold are included in the set C2.

If it is determined in step 506 that the Unrecognized Word is not preceded by any recognized word, then in step 308 the candidate extraction engine 154 determines whether the Unrecognized Word is succeeded by any recognized word (step 508). If not, in one embodiment, the candidate extraction engine 154 returns with no candidate spell-check suggestions (step 510). If so, the candidate extraction engine 154 retrieves a set (C2) of words that are recognized in the vocabulary statistics database 148 as being known to precede the Succeeding Recognized Word (step 518). In an embodiment, the candidate extraction engine 154 accesses the vocabulary statistics database 148, searches for the Succeeding Recognized Word, and retrieves all words that appear as preceding the Succeeding Recognized Word. This set makes up the set C2. In one embodiment, all words that appear in the statistics database 148 as preceding the Succeeding Recognized Word are included in the set C2. In an alternative embodiment, only words whose Reverse Sequence Count meets or exceeds a predetermined threshold are included in the set C2.

Step 514, 516 and 518 flow to Step 520 with one or both sets C1 and/or C2 of words that statistically precede or succeed a recognized word. The candidate extraction engine 154 returns the union of C1 and C2 as candidate spell-check suggestions (step 520).

At this point we have a set of correction candidates which are very likely to occur based on the words immediately preceding or following it. In an embodiment, the candidate spell-check suggestions are sorted according to a score (step 522). The sorted correction candidates may then be presented to the user (step 524), who can then select the correction candidate to use. Alternatively, such as when the statistical spell checker is being used as part of a search engine, the search engine can be configured to automatically select the candidate with the highest score and run the search query based on the query containing the selected correction candidate (step 526) and then presenting the query results (based on the corrected query) to the user (step 528).

There are various ways to select which correction candidate to select and/or to order the correction candidates for presentation to the user. In one embodiment, a statistical score (S) is calculated (step 530) for each correction candidate based on the conditional probability of the correction candidate appearing before or after a detected preceding or succeeding recognized word given the detected preceding or succeeding recognized word. That is, if a given candidate sequence includes the candidate word preceded by a recognized word, the score is based on the conditional probability P(W₂|W₁). If instead a given candidate sequence includes the candidate word succeeded by a recognized word, the score is based on the conditional probability P(W₁|W₂). If a recognized word appears both before and after the candidate word for the Unrecognized Word, the score is the sum of the conditional probabilities of the word appearing before, and after, the Unrecognized Word. That is, P(W|previous word is in C1)+P(W|next word is in C2).

In another embodiment, the Edit Distance from the original Unrecognized Word to each correction candidate is calculated and the best match (taking into account both the statistical score (S) described above and the edit distance score itself) is selected. The final score may be calculated by multiplying the statistical score (S) by the inverse of the Edit Distance (which should always be non-zero, since the original word was not in the vocabulary, but any suggestion is) (step 532). Note that in this case, the Edit Distance search space is significantly reduced when compared to traditional Edit-Distance spell checking described in the background by intelligently choosing likely candidates prior to making comparisons, thus making the spell checking much faster and reliable.

In an alternative embodiment, the correction candidates can be run through a phonetic encoder to find the candidate that sounds most alike the original word (step 534).

Alternative correction candidate selection methods may also be used.

Regardless of how the correction candidates are sorted, the correction candidates may be presented to the user, indicating the correction candidate(s) with the highest statistical score (S) first, for user selection (step 524). The search engine can also select the correction candidate with the highest score and perform the search based on a query containing the selected correction candidate (step 526). The query results based on the corrected query can then be automatically presented to the user (step 528).

In an embodiment, the vocabulary statistics engine is configurable to allow a user to specify sequences of adjacent words or characters that are to be ignored. This may be useful, for example, if some of the documents contain numerical data, or certain common phrases that are not statistically significant to a query. For example, where the spell-checking engine is used by an Internet search engine, the two-word sequence “and a” might be flagged to be ignored by the vocabulary statistics engine 152 since neither word in the sequence is considered a substantive word and the sequence is so common. On the other hand, where the spell-checking engine is used in a word processor or other office application, the word sequence “and a” might not be flagged to ignore precisely because it is such a common two-word sequence and any mis-typing the part of the user entering the “and a” sequence would desirably and likely be returned high in the list of candidate suggestions.

In the embodiments described so far, statistics are collected based on 2-word sequences of adjacent words. Collection of statistical information can be expanded to include longer sequences of words. For example, in a 3-word sequence, the number of times each 3-word sequence of adjacent words appears in the document corpus 140 can be recorded, and the conditional probabilities of a word given the appearance of a recognized preceding word and a recognized succeeding word can be calculated as well. Higher scores are attributed to higher conditional probabilities for 3-word sequences than for two-word sequences. These types of statistics can be extended up to sequences of any desired number of adjacent words.

As an illustrative example of the operation of the statistical spell-checker 105, suppose that a user enters the query “Fee Business Cards” in the site search query box 402 in the home page 410 of FIG. 4. The statistical spell checker 150 receives the query “Fee Business Cards” from the query box 402 and determines that the word “Fee” is an Unrecognized Word (because it is not in the vocabulary database since none of the web pages from which the vocabulary database was built contain the word “fee”). The candidate extraction engine 154 determines that there is no word in the query that precedes the Unrecognized Word “Fee”. However, since the Unrecognized Word “Fee” is succeeded by a Recognized Word “Business”, the candidate extraction engine 154 finds all 2-word sequences in the vocabulary statistics database 148 and returns them as suggested spell-check candidates 104. In the present example, since the sequence “Free Business” is the only recognized 2-word sequence that contains the recognized word “Business” preceded by another word, the sequence “Free Business” is returned as a possible candidate 104 for the unrecognized sequence “fee business”. If there had been more sequences in the vocabulary statistics database 148 containing a recognized word followed by the Recognized Word “Business”, then these too would be returned, preferably in order of highest-to-lowest conditional probability. If the user view the suggested spell-check candidate and agrees that the suggested candidate is indeed what the user meant, the user can click on the suggested query 104 to have the suggested query run by the server 120.

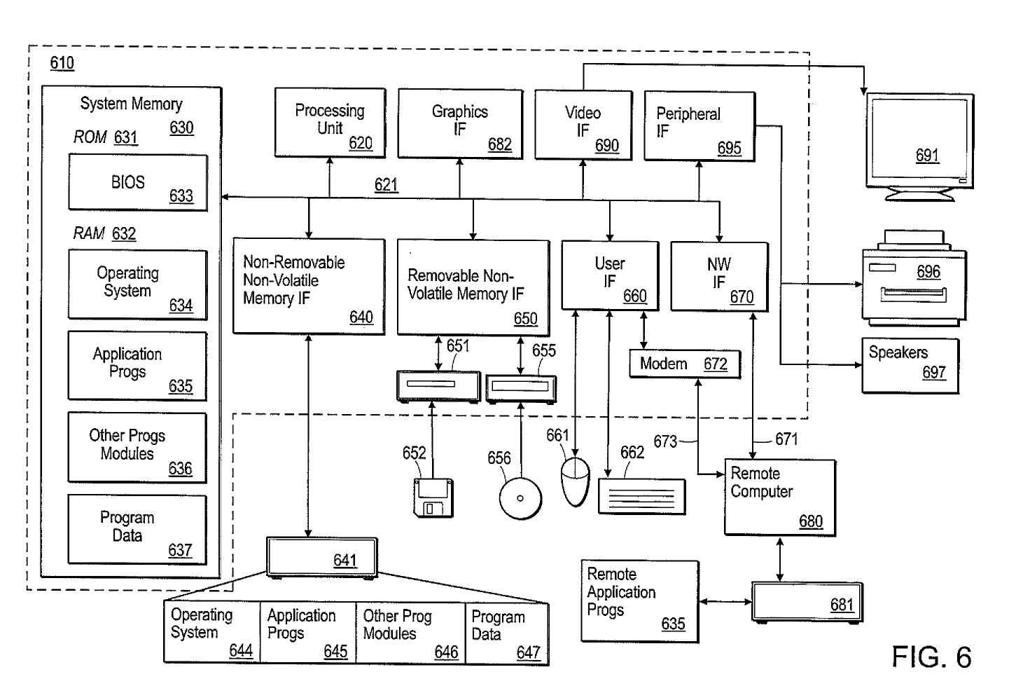

FIG. 6 illustrates a computer system 610 that may be used to implement any of the servers and computer systems discussed herein, including the Crawler system 110, 200, the Indexer 130, the Query Engine 150, Client(s) 170, and any server on the Internet. Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 610. Computer storage media typically embodies computer readable instructions, data structures, program modules or other data.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 640 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6 provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through an output peripheral interface 690.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Although preferred embodiments of the present invention have been disclosed for illustrative purposes, those skilled in the art will appreciate that various modifications, additions and substitutions are possible, without departing from the scope and spirit of the invention as disclosed in the accompanying claims. For example, those of skill in the art will appreciate that the methods and systems described and illustrated herein may be implemented in software, firmware or hardware, or any suitable combination thereof. Preferably, the method and apparatus are implemented in software, for purposes of low cost and flexibility. Thus, those of skill in the art will appreciate that the method and apparatus of the invention may be implemented by one or more processors executing computer-readable program instructions stored in non-transitory computer-readable memory. Alternative embodiments are contemplated, however, and are within the spirit and scope of the invention.

What is claimed is:

1. A method for extracting suggested spell-check candidates for a query containing an unrecognized word, the method comprising the steps of;
determining a plurality of adjacent word sequences found in a document corpus, the adjacent word sequences comprising a plurality of adjacent recognized words;
determining whether the unrecognized word is preceded by a preceding recognized word in the query;
determining whether the unrecognized word is succeeded by a succeeding recognized word in the query;
returning one or more of the adjacent word sequences that comprises at least the preceding recognized word in the query followed by a suggested or a suggested correction candidate in place of the unrecognized word succeeded by the succeeding recognized word in the query.

2. The method of claim 1, wherein the returned adjacent word sequences are prioritized based on conditional probability that the unrecognized word is a corresponding suggested known vocabulary word given the recognized word.

3. The method of claim 1, further comprising:
determining for each determined adjacent word sequence a forward sequence count of how many of the determined adjacent word sequence exist in the document corpus in forward sequential order;
calculating, at least for those returned adjacent word sequences corresponding to a forward adjacent sequence, the conditional probability that the unrecognized word is the suggested known vocabulary word preceded by the preceding recognized word in the query given the preceding recognized word in the query;
assigning relative scores to the returned adjacent word sequences based on the calculated conditional probability; and
returning the determined adjacent word sequences in order of highest score to lowest score.

4. The method of claim 3, wherein the relative scores are assigned to the returned adjacent word sequences based on the calculated conditional probability of the suggested correction candidate given the preceding recognized word or succeeding recognized word, and the edit distance of the suggested correction candidate from the unrecognized word.

5. The method of claim 1, further comprising:
running the suggested candidate correction in each returned adjacent word sequence through a phonetic encoder; and
sorting the returned adjacent word sequences based on how closely the suggested candidate correction in each returned adjacent word sequence phonetically matches the unrecognized word.

6. Non-transitory computer readable storage tangibly embodying program instructions which, when executed by a computer, implement a method for extracting suggested spell-check candidates for a query containing an unrecognized word, the method comprising the steps of:
determining a plurality of adjacent word sequences found in a document corpus, the adjacent word sequences comprising a plurality of adjacent recognized words;
determining whether the unrecognized word is preceded by a preceding recognized word in the query;
determining whether the unrecognized word is succeeded by a succeeding recognized word in the query;
returning one or more of the adjacent word sequences that comprises at least the preceding recognized word in the query followed by a suggested known vocabulary word or a suggested known vocabulary word succeeded by the succeeding recognized word in the query.

7. The non-transitory computer readable storage of claim 6, wherein the returned adjacent word sequences are prioritized based on conditional probability that the unrecognized word is a corresponding suggested known vocabulary word given the recognized word.

8. The non-transitory computer readable storage of claim 6, the method further comprising:
determining for each determined adjacent word sequence a forward sequence count of how many of the determined adjacent word sequence exist in the document corpus in forward sequential order;
calculating, at least for those returned adjacent word sequences corresponding to a forward adjacent sequence, the conditional probability that the unrecognized word is the suggested known vocabulary word preceded by the preceding recognized word in the query given the preceding recognized word in the query;
assigning relative scores to the retuned adjacent word sequences based on the calculated conditional probability; and
returning the determined adjacent word sequences in order of highest score to lowest score.

9. The non-transitory computer readable storage of claim 8, wherein the relative scores are assigned to the returned adjacent word sequences based on the calculated conditional probability of the suggested correction candidate given the preceding recognized word or succeeding recognized word, and the edit distance of the suggested correction candidate from the unrecognized word.

10. The non-transitory computer readable storage of claim 6, the method further comprising:
running the suggested candidate correction in each returned adjacent word sequence through a phonetic encoder; and
sorting the returned adjacent word sequences based on how closely the suggested candidate correction in each returned adjacent word sequence phonetically matches the unrecognized word.

11. A statistical spell-checking apparatus, comprising:
one or more processors configured to execute a vocabulary statistics engine, the vocabulary statistics engine configured to process a document corpus to build a vocabulary statistics database comprising a plurality of sequences of adjacent words found in the document corpus, the vocabulary statistics engine further configured to calculate a conditional probability of a suggested candidate correction for an unrecognized word given a recognized word in a query that either precedes or succeeds the unrecognized word in the query; and
one or more processors configured to receive a query from a user, detect an unrecognized word in the query, request one or more candidate corrections for the unrecognized word, and present the one or more candidate corrections to a user for selection.
